(19) United States
(12) Patent Application Publication
(10) Pub. No.: US 2023/0267670 A1
(43) Pub. Date: Aug. 24, 2023

(54) APPARATUS AND METHOD FOR SERVING ONLINE VIRTUAL PERFORMANCE AND SYSTEM FOR SERVING ONLINE VIRTUAL PERFORMANCE

(71) Applicant: ELECTRONICS AND TELECOMMUNICATIONS RESEARCH INSTITUTE, Daejeon (KR)

(72) Inventors: Yong-Wan KIM, Daejeon (KR); Ki-Hong KIM, Sejong-si (KR); Dae-Hwan KIM, Sejong-si (KR); Jin-Sung CHOI, Daejeon (KR)

(21) Appl. No.: 17/986,970

(22) Filed: Nov. 15, 2022

(30) Foreign Application Priority Data
Feb. 18, 2022 (KR) 10-2022-0021443

(51) Int. Cl. G06T 13/40; G06V 40/16; G06T 7/20; G06T 13/20; H04S 7/00; G10L 25/51

(52) U.S. Cl. CPC G06T 13/40; G06V 40/174; G06T 7/20; G06T 13/205; H04S 7/30; G10L 25/51; H04S 2400/11; H04S 2400/15

(57) ABSTRACT

Disclosed herein is an apparatus for an online virtual performance. The apparatus may include a performer streaming server for creating real-time motion information of a performer and sound information and transmitting the same to a performance server, an audience participation server for mapping a remotely accessing audience to a previously created zone area, calculating context meta information of the zone area based on individual context information of the audience, and transmitting the calculated context meta information and voice information, among the context information of the audience, to the performance server, and a virtual audience creation unit for creating individual context information of an audience and transmitting the same to the audience participation server.

### CROSS REFERENCE TO RELATED APPLICATION

This application claims the benefit of Korean Patent Application No. 10-2022-0021443, filed Feb. 18, 2022, which is hereby incorporated by reference in its entirety into this application.

### BACKGROUND OF THE INVENTION

### 1. Technical Field

The present disclosure relates to an apparatus and method for an online virtual performance capable of accommodating a large audience.

### 2. Description of Related Art

Recently, COVID-19 has accelerated online activities and has created a new type of online virtual performance market that enables an audience from all over the world to enjoy the performance of a performer in a virtual performance space without physical limitations, simultaneously with an in-person performance.

The currently provided online virtual performance platforms fail to provide real-time responsiveness and a sense of realism at the same level as provided by existing in-person performances. In order to overcome these disadvantages, a method in which an audience member creates an avatar in a first-person perspective to represent his/her appearance and motion and participates in a virtual performance is being developed.

However, when an audience of more than ten thousands gathers to participate in a virtual performance, a huge amount of user data may cause latency, rendering loads, and the like. Conversely, when an audience is limited to a certain extent, there is a limitation in providing a sense of realism of a virtual performance.

### SUMMARY OF THE INVENTION

An object of the present disclosure is to provide an apparatus and method for an online virtual performance to which a large audience is able to participate.

Another object of the present disclosure is to provide an apparatus and method for an online virtual performance through which an audience is able to view a high-quality virtual performance.

In order to accomplish the above objects, an apparatus for an online virtual performance according to the present disclosure may include a performer streaming server for creating real-time motion information of a performer and sound information and transmitting the same to a performance server, an audience participation server for mapping a remotely accessing audience to a previously created zone area, calculating context meta information of the zone area based on individual context information of the audience, and transmitting the calculated context meta information and voice information, among the context information of the audience, to the performance server, and a virtual audience creation unit for creating individual context information of an audience and transmitting the created individual context information to the audience participation server.

The performer streaming server may include a motion collection unit for collecting the real-time motion of the performer, a sound collection unit for collecting the sound information, and a mixing unit for mixing the real-time motion of the performer and the sound information.

The sound information may include the voice of the performer and sound of musical instruments and speakers around the performer.

The audience participation server may divide the zone area into a main zone and a subzone based on the distance from the audience and transmit context meta information of the main zone and the voice information, among the context information of the audience, to the performance server.

The virtual audience creation unit may receive context meta information of each zone from the audience participation server, reconfigure an audience for each zone, and provide the audience to the audience participation server.

The virtual audience creation unit may extract the context information of the audience based on the appearance, the motion, and the voice of the audience and on facial emotion recognition data of the audience based on a single image.

The context information of the audience may include a level of cheers of the audience.

The virtual audience creation unit may receive the sound information from the performer streaming server and create a virtual audience of the subzone based on the appearance and motion information of an audience and the sound information.

The audience participation server may include functional servers for functions including login, a performance space audience participation zone, an event, and voice mixing.

Also, a method for an online virtual performance according to an embodiment may include creating, by a performer streaming server, real-time motion information of a performer and sound information and transmitting, by the performer streaming server, the real-time motion information and the sound information to a performance server; creating, by a virtual audience creation unit, individual context information of a remotely accessing audience and transmitting, by the virtual audience creation unit, the created individual context information to an audience participation server; and mapping, by the audience participation server, an audience to a previously created zone area, calculating, by the audience participation server, context meta information of the zone area based on individual context information of the audience, and transmitting, by the audience participation server, the calculated context meta information and voice information, among the context information of the audience, to the performance server.

Creating the real-time motion information of the performer and the sound information and transmitting the same to the performance server may include collecting the real-time motion of the performer, collecting the sound information, and mixing the real-time motion of the performer and the sound information.

The sound information may include sound of the performer and sound of musical instruments and speakers around the performer.

Transmitting the context meta information and the voice information, among the context information of the audience, to the performance server may comprise dividing the zone area into a main zone and a subzone based on the distance from the audience and transmitting context meta information of the main zone and the voice information, among the context information of the audience, to the performance server.

The method may further include receiving, by the virtual audience creation unit, context meta information of each zone from the audience participation server, reconfiguring, by the virtual audience creation unit, an audience for each zone, and providing, by the virtual audience creation unit, the audience to the audience participation server.

Transmitting the created individual context information to the audience participation server may comprise extracting context information of the audience based on the appearance, the motion, and the voice of the audience and on facial emotion recognition data of the audience based on a single image.

The context information of the audience may include a level of cheers of the audience.

Transmitting the created individual context information to the audience participation server may comprise receiving the sound information and creating a virtual audience of the subzone based on the appearance and motion information of the audience and the sound information.

The audience participation server may include functional servers for functions including login, a performance space audience participation zone, an event, and voice mixing.

Also, a system for an online virtual performance according to an embodiment may include a performance server for proceeding with an online virtual performance, a performer streaming server for creating real-time motion information of a performer and sound information and transmitting the same to the performance server, an audience participation server for mapping an audience to a previously created zone area, calculating context meta information of the zone area based on individual context information of the audience, and transmitting the calculated context meta information and voice information, among the context information of the audience, to the performance server, and a virtual audience creation unit for creating individual context information of an audience and transmitting the created individual context information to the audience participation server.

The audience participation server may divide the zone area into multiple zone areas including a main zone and a subzone based on the distance from the audience and transmit context meta information of the main zone and the voice information, among the context information of the audience, to the performance server.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a block diagram illustrating an online virtual performance system according to an embodiment;

FIG. 2 is a block diagram illustrating an apparatus for an online virtual performance according to an embodiment;

FIG. 3 is a block diagram illustrating a performer streaming server of an apparatus for an online virtual performance according to an embodiment;

FIG. 4 is a block diagram illustrating an audience participation server of an apparatus for an online virtual performance according to an embodiment;

FIG. 5 is a block diagram illustrating a virtual audience creation unit of an apparatus for an online virtual performance according to an embodiment;

FIG. 6 is a flowchart illustrating a method for an online virtual performance according to an embodiment;

FIG. 7 is a view for explaining a method for an online virtual performance according to an embodiment; and

FIG. 8 is a block diagram illustrating the configuration of a computer system according to an embodiment of the present disclosure.

### DESCRIPTION OF THE PREFERRED EMBODIMENTS

The advantages and features of the present disclosure and methods of achieving the same will be apparent from the exemplary embodiments to be described below in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only, and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

Hereinafter, embodiments of the present disclosure will be described in detail with reference to the accompanying drawings. In the following description of the present disclosure, the same reference numerals are used to designate the same or similar elements throughout the drawings, and repeated descriptions of the same components will be omitted.

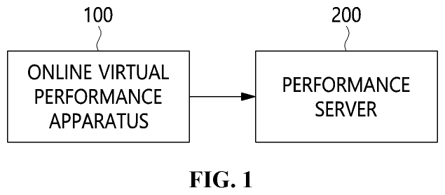

FIG. 1 is a block diagram illustrating an online virtual performance system according to an embodiment.

Referring to FIG. 1, an online virtual performance system according to an embodiment may include an online virtual performance apparatus 100 and a performance server 200.

The virtual performance apparatus 100 may process data about a performer and an audience for a virtual performance. The virtual performance apparatus 100 may process data so as to prevent latency in performer's streaming and to accommodate a large audience.

The performance server 200 may proceed with a virtual performance according to the performance content of a performer.

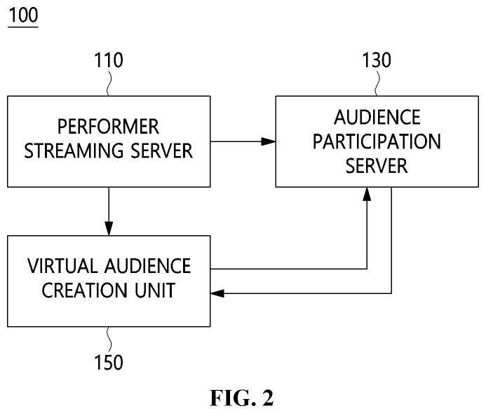

FIG. 2 is a block diagram illustrating an apparatus for an online virtual performance according to an embodiment.

As illustrated in FIG. 2, the virtual performance apparatus 100 may include a performer streaming server 110, an audience participation server 130, and a virtual audience creation unit 150.

The performer streaming server 110 may create motion information of a performer and sound information. The performer streaming server 110 may use an independently managed protocol in order to deliver a performance without delay or interruption. In order to synchronize performance data, the performer streaming server 110 may mix real-time motion-capture data of a performer and the live recording sound of an in-person performance of a remote performer in a multi-channel sound format so as to be available for a virtual performance in a virtual-reality environment, and may perform broadcast streaming in order to deliver the mixed data.

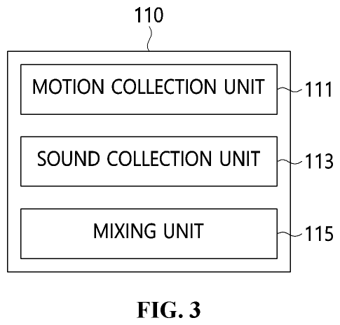

FIG. 3 is a block diagram illustrating the performer streaming server of an apparatus for an online virtual performance according to an embodiment.

As illustrated in FIG. 3, the performer streaming server 110 may include a motion collection unit 111, a sound collection unit 113, and a mixing unit 115.

The motion collection unit 111 may collect the real-time motion of a performer. The sound collection unit 113 may collect sound required for a performance. The sound may include the voice of a performer and sound from musical instruments and speakers around the performer. The mixing unit 115 may mix the real-time motion of the performer and the sound of the performer in a multi-channel format.

3D virtual position information pertaining to musical instruments, speakers, and the like may be transmitted to the virtual audience creation unit 150, along with the motion and sound data of a performer, which is collected by the performer streaming server 110.

Referring back to FIG. 2, the audience participation server 130 may map an audience to a previously created zone area, calculate context meta information of the zone area based on individual context information of the audience, and transmit the calculated context meta information and voice information, among the context information of the audience, to the performance server 200.

More specifically, the audience participation server 130 may run a server for each function, map audience members to zone servers to be distributed, and perform synchronization so that it looks as if a large online audience gathered in the performance space. The audience participation server 130 may divide the zone area into multiple zones depending on the distance from the position of an audience, and for example, the zone may be divided into a main zone and short/middle/long-distance subzones.

For the short-distance subzone, a real-time appearance and motion of an audience may be continuously delivered thereto. Also, for the subzones at middle/long distances, zone context meta information including zone activeness, such as the level of cheers, may be delivered to the virtual audience creation unit 150.

Also, the audience participation server 130 may mix the massive sound of a large audience participating in a performance for each zone and deliver a group sound source mixed depending on the distance (short/middle/long distances) to the virtual audience creation unit 150.

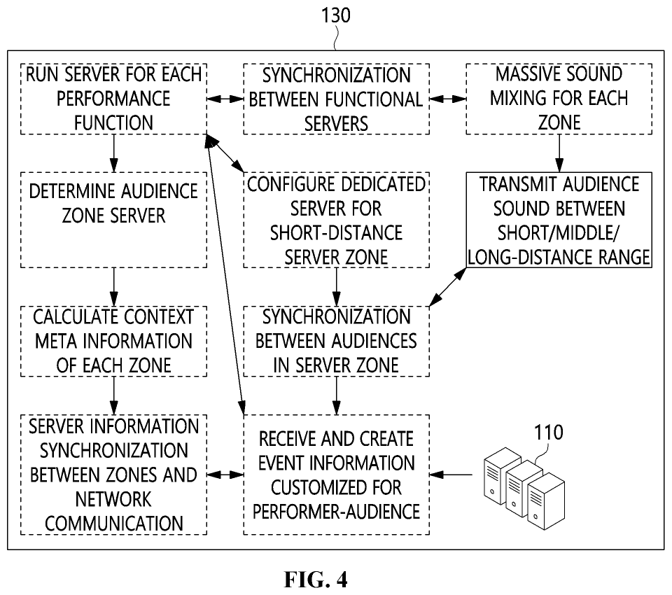

FIG. 4 is a block diagram illustrating the audience participation server of an apparatus for an online virtual performance according to an embodiment.

As illustrated in FIG. 4, the audience participation server 130 may run functional servers for respective performance elements, such as login, a performance space audience participation zone, an event, voice mixing, and the like.

A master server function for performing synchronization between the functional servers at certain periods is provided, so context meta information or event data may be synchronized between audience members participating in respective zones.

In the functional server, invisible zones in a virtual performance space are separated, and an audience is mapped to an audience participation zone server depending on the seat numbers determined when the audience is ticketed at the time of login.

The method of dividing a zone may use a grid type, which divides the zone by a fixed size, or concentric circles having different sizes, but is not limited thereto.

The audience participation server 130 calculates context meta information of each zone depending on the individual context information detected in an audience. As group context of interest, activeness context, such as the level of cheers of a group, may be used as context meta information for representing the zone.

The appearance and motion information of individual audience members are not delivered to the performance server 200, and only meta information and voice information are delivered thereto. A reflection of changes in the appearance and motion of an individual audience member may be delivered only to a few audience members around the corresponding audience member. To this end, a dedicated server for configuring a short-distance subzone may be formed for an individual audience member and audience members around the corresponding audience member.

The dedicated server is configured to deliver and synchronize only information about appearance and motion changes and a mixed group sound source within a corresponding subzone in a peer-to-peer manner, without passing through the performance server 200. As a result, the amount of data that has to be handled by the performance server may be significantly reduced, and a change in a large audience may be reflected.

In existing games, there is only need to transfer the ID of a predefined game motion animation, but the performance server 200 is required to receive and transmit changes in appearances and motion data of an audience member and people around the audience member in real time. Accordingly, transmitting/receiving data pertaining to an audience of about ten thousands to/from the performance server 200 and synchronizing the data may require large network bandwidth and cause latency and rendering loads. Therefore, for an individual audience member and people around the audience member, a subzone server is configured to share data in real time, and the audience participation server 130 delivers only voice and recognized individual context information.

Also, when server information is synchronized between zones, only simplified information, such as content execution information, performance event information, context meta information between zones, and the like, is used in order to minimize the information to be synchronized. In the case of voices, voices of a large number of users are mixed in order to give a sense of realism as if a large audience were in a single space, and the virtual audience creation unit 150 may mix massive sounds for each zone, rather than mixing all sounds at once, and deliver the same in order to create a 3D sound and a sense of space depending on the distance or position.

In the case of the sound of an audience at a short distance, the sound of each of neighboring audience members may be delivered to the virtual audience creation unit 150 through a subzone server. The performance server 200 mixes sound sources for each zone and delivers a single sound source for each zone to the virtual audience creation unit 150. In the case of an event between a performer and an audience during a performance, multiple audience members may experience customized events provided by the single performer.

The motion of the performer is received from the performer streaming server 110, and event information may be created and delivered to the virtual audience creation unit 150 to create an event. For example, the handshake motion of a performer is received from the performer streaming server 110 and the motion is changed to be customized for multiple audience members such that they are able to experience the event.

Referring back to FIG. 2, the virtual audience creation unit 150 plays a role to create individual context information of an audience, to represent a large audience of each zone by receiving context meta information of an audience group of the zone, and to enable experiencing a performance depending on received content event information.

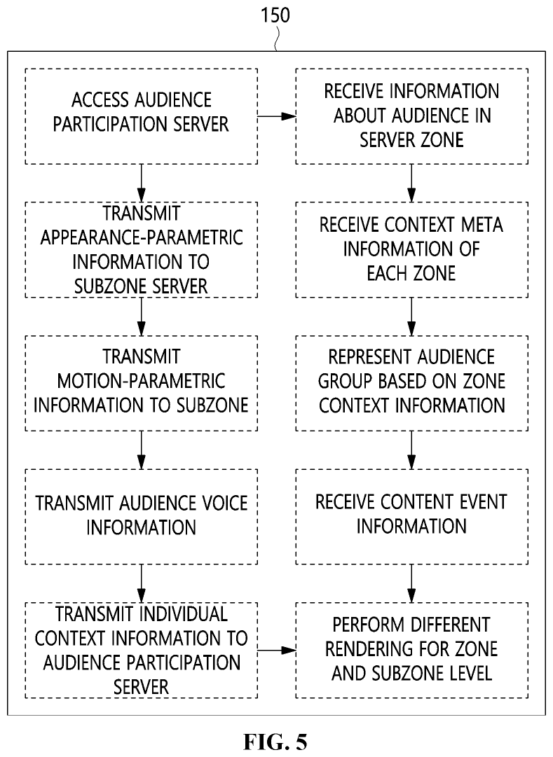

FIG. 5 is a block diagram illustrating the virtual audience creation unit of an apparatus for an online virtual performance according to an embodiment.

As illustrated in FIG. 5, the virtual audience creation unit 150 may extract an appearance and a motion as some parameters through a fitting process, which reprojects a parametric appearance template configured as a blend shape onto a 2D image of a webcam, and a pose estimation process, and transfer the parameters to the neighboring audience through a subzone network.

The virtual audience creation unit 150 may extract individual context information corresponding to activeness, such as the level of cheers or the like, using data including the appearance and motion of an audience, voices, facial emotion recognition data based on a single RGB image of a webcam, and the like and transmit the extracted information to the audience participation server 130. Here, voices may be simultaneously delivered to both the audience participation server 130 and the individual subzone server.

Also, the virtual audience creation unit 150 may receive the appearance and motion information of an audience in the subzone and receive context meta information of each zone from the audience participation server 130.

The virtual audience creation unit 150 may create activeness of an audience group, such as avatars of each zone, based on zone context information corresponding to activeness, such as the level of cheers in each zone. A variety of animation data based on the activeness level may be created and stored in advance.

In addition to the context of each zone created depending on the activeness, neighboring audience data is differently rendered based on the zone and subzone levels according to the distance by reflecting appearance and motion changes delivered in real time.

In the case of event creation data, the virtual audience creation unit 150 may perform a natural event process customized for an audience member based on the data of the performer and event synchronization information delivered thereto.

For the mixed voice of each zone, the virtual audience creation unit 150 performs a process of producing a 3D sound image and ambience depending on the distance and the position, thereby minimizing the sound-processing load imposed on the performance server.

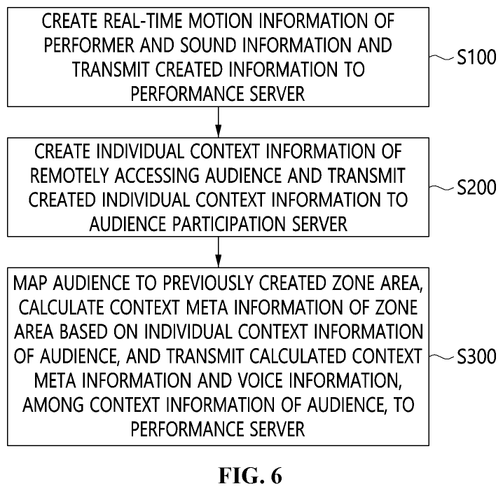

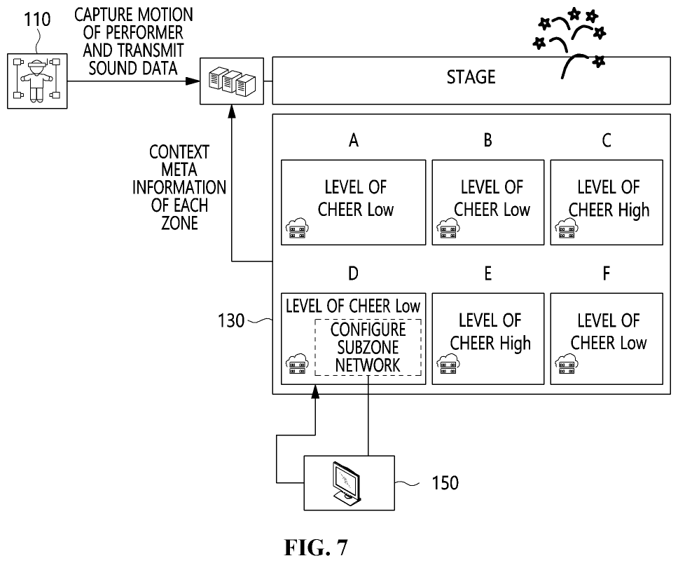

FIG. 6 is a flowchart illustrating a method for an online virtual performance according to an embodiment, and FIG. 7 is a view for explaining a method for an online virtual performance according to an embodiment. Here, the method for an online virtual performance may be performed by a virtual performance apparatus.

Referring to FIG. 6, the performer streaming server of the virtual performance apparatus 100 may collect real-time motion of a performer and sound information. The sound information may include the voice of the performer and the sound of musical instruments near the performer. The performer streaming server of the virtual performance apparatus 100 may mix the collected motions and sound information and transmit the same to a performance server at step S100.

The virtual audience creation unit of the virtual performance apparatus 100 may create individual context information of an audience at step S200.

The audience participation server of the virtual performance apparatus 100 may map an audience to a previously created zone area, calculate context meta information of the zone area, and transmit the same to the performance server. The online virtual performance apparatus may transmit voice information of the performer to the performance server, along with the context meta information, at step S300.

As illustrated in FIG. 7, multiple zone areas may be created in the audience participation server, and areas A, B, D, and F may be areas in which the level of cheers of the audience is low, and areas C and E may be areas in which the level of cheers of the audience is high.

Referring back to FIG. 6, the virtual audience creation unit of the virtual performance apparatus 100 may perform different rendering for each zone and transmit the result thereof. Accordingly, a large audience may be differently represented in the respective zones.

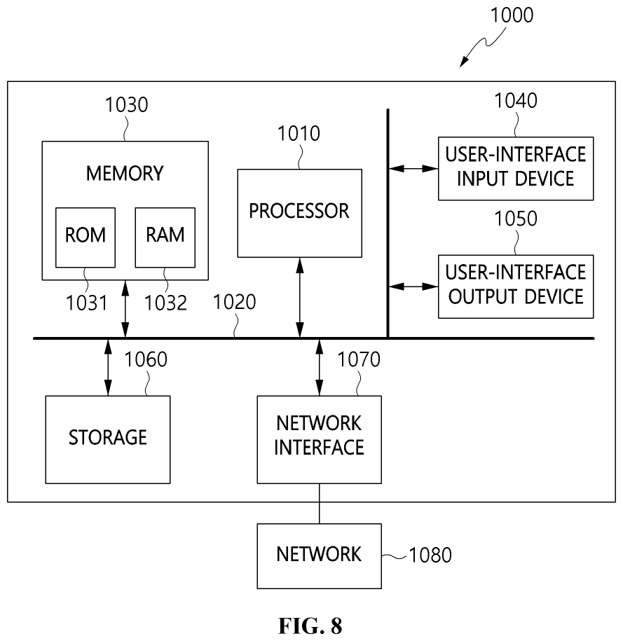

FIG. 8 is a block diagram illustrating the configuration of a computer system according to an embodiment of the present disclosure.

The virtual performance apparatus according to an embodiment may be implemented in a computer system including a computer-readable recording medium.

Referring to FIG. 8, the computer system 1000 according to an embodiment may include one or more processors 1010, memory 1030, a user-interface input device 1040, a user-interface output device 1050, and storage 1060, which communicate with each other via a bus 1020. Also, the computer system 1000 may further include a network interface 1070 connected to a network.

The processor 1010 may be a central processing unit or a semiconductor device for executing a program or processing instructions stored in the memory or the storage. The processor 1010 is a kind of central processing unit, and may control the overall operation of the virtual performance apparatus or the system.

The processor 1010 may include all kinds of devices capable of processing data. Here, the ‘processor’ may be, for example, a data-processing device embedded in hardware, which has a physically structured circuit in order to perform functions represented as code or instructions included in a program. Examples of the data-processing device embedded in hardware may include processing devices such as a microprocessor, a central processing unit (CPU), a processor core, a multiprocessor, an application-specific integrated circuit (ASIC), a field-programmable gate array (FPGA), and the like, but are not limited thereto.

The memory 1030 may store various kinds of data for overall operation, such as a control program, and the like, for performing a virtual performance method according to an embodiment. Specifically, the memory may store multiple applications running in the virtual performance apparatus or the system and data and instructions for operation of the virtual performance apparatus or the system.

The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

According to an embodiment, the computer-readable recording medium storing a computer program therein may contain instructions for making a processor perform a method including an operation for creating real-time motion information of a performer and sound information and transmitting the same to a performance server, an operation for creating individual context information of a remotely accessing audience and transmitting the same to an audience participation server, and an operation for mapping an audience to a previously created zone area, calculating context meta information of the zone area based on the individual context information of the audience, and transmitting the calculated context meta information and voice information, among the context information of the audience, to the performance server.

The present disclosure has an effect of reducing latency, rendering loads, and the like resulting from a huge amount of data that is generated when a large online audience is accommodated.

Also, the present disclosure assigns a large audience to a zone and a subzone and reconfigures only context meta information about activeness, such as the level of cheers, for the zone, thereby having an effect of reducing a data amount.

Also, the present disclosure parameterizes changes in appearances, motions, and the like of a neighboring audience and configures a subzone server, thereby having an effect of improving a sense of realism and reality.

Also, the present disclosure delivers and processes only a sound source mixed in a server, rather than individual voices, for each zone, thereby reducing the amount of data and a computational load when a large online audience is present. Accordingly, the present disclosure has effects of enabling the broadcast of a performer to be seamlessly streamed and delivering a vivid sense of realism as if a large audience gathered.

Specific implementations described in the present disclosure are embodiments and are not intended to limit the scope of the present disclosure. For conciseness of the specification, descriptions of conventional electronic components, control systems, software, and other functional aspects thereof may be omitted. Also, lines connecting components or connecting members illustrated in the drawings show functional connections and/or physical or circuit connections, and may be represented as various functional connections, physical connections, or circuit connections that are capable of replacing or being added to an actual device. Also, unless specific terms, such as “essential”, “important”, or the like, are used, the corresponding components may not be absolutely necessary.

Accordingly, the spirit of the present disclosure should not be construed as being limited to the above-described embodiments, and the entire scope of the appended claims and their equivalents should be understood as defining the scope and spirit of the present disclosure.

What is claimed is:

1. An apparatus for an online virtual performance, comprising:
a performer streaming server for creating real-time motion information of a performer and sound information and transmitting the real-time motion information and the sound information to a performance server;
an audience participation server for mapping a remotely accessing audience to a previously created zone area, calculating context meta information of the zone area based on individual context information of the audience, and transmitting the calculated context meta information and voice information, among the context information of the audience, to the performance server; and
a virtual audience creation unit for creating individual context information of an audience and transmitting the created individual context information to the audience participation server.

2. The apparatus of claim 1, wherein the performer streaming server includes
a motion collection unit for collecting a real-time motion of the performer,
a sound collection unit for collecting the sound information, and
a mixing unit for mixing the real-time motion of the performer and the sound information.

3. The apparatus of claim 2, wherein the sound information includes a voice of the performer and sound of musical instruments and speakers around the performer.

4. The apparatus of claim 1, wherein the audience participation server divides the zone area into a main zone and a subzone based on a distance from the audience and transmits context meta information of the main zone and the voice information, among the context information of the audience, to the performance server.

5. The apparatus of claim 4, wherein the virtual audience creation unit receives context meta information of each zone from the audience participation server, reconfigures an audience for each zone, and provides the audience to the audience participation server.

6. The apparatus of claim 1, wherein the virtual audience creation unit extracts the context information of the audience based on an appearance, a motion, and a voice of the audience and on facial emotion recognition data of the audience based on a single image.

7. The apparatus of claim 6, wherein the context information of the audience includes a level of cheers of the audience.

8. The apparatus of claim 4, wherein the virtual audience creation unit receives the sound information from the performer streaming server and creates a virtual audience of the subzone based on an appearance and motion information of an audience and the sound information.

9. The apparatus of claim 1, wherein the audience participation server includes functional servers for functions including login, a performance space audience participation zone, an event, and voice mixing.

10. A method for an online virtual performance, comprising:
creating, by a performer streaming server, real-time motion information of a performer and sound information and transmitting, by the performer streaming server, the real-time motion information and the sound information to a performance server;
creating, by a virtual audience creation unit, individual context information of a remotely accessing audience and transmitting, by the virtual audience creation unit, the created individual context information to an audience participation server; and
mapping, by the audience participation server, an audience to a previously created zone area, calculating, by the audience participation server, context meta information of the zone area based on individual context information of the audience, and transmitting, by the audience participation server, the calculated context meta information and voice information, among the context information of the audience, to the performance server.

11. The method of claim 10, wherein creating the real-time motion information of the performer and the sound information and transmitting the real-time motion information and the sound information to the performance server includes
collecting a real-time motion of the performer,
collecting the sound information, and
mixing the real-time motion of the performer and the sound information.

12. The method of claim 11, wherein the sound information includes sound of the performer and sound of musical instruments and speakers around the performer.

13. The method of claim 10, wherein transmitting the context meta information and the voice information, among the context information of the audience, to the performance server comprises dividing the zone area into a main zone and a subzone based on a distance from the audience and transmitting context meta information of the main zone and the voice information, among the context information of the audience, to the performance server.

14. The method of claim 13, further comprising:
receiving, by the virtual audience creation unit, context meta information of each zone from the audience participation server, reconfiguring, by the virtual audience creation unit, an audience for each zone, and providing, by the virtual audience creation unit, the audience to the audience participation server.

15. The method of claim 10, wherein transmitting the created individual context information to the audience participation server comprises extracting context information of the audience based on an appearance, a motion, and a voice of the audience and on facial emotion recognition data of the audience based on a single image.

16. The method of claim 15, wherein the context information of the audience includes a level of cheers of the audience.

17. The method of claim 13, wherein transmitting the created individual context information to the audience participation server comprises receiving the sound information and creating a virtual audience of the subzone based on an appearance and motion information of the audience and the sound information.

18. The method of claim 10, wherein the audience participation server includes functional servers for functions including login, a performance space audience participation zone, an event, and voice mixing.

19. A system for an online virtual performance, comprising:
a performance server for proceeding with an online virtual performance;
a performer streaming server for creating real-time motion information of a performer and sound information and transmitting the real-time motion information and the sound information to the performance server;
an audience participation server for mapping an audience to a previously created zone area, calculating context meta information of the zone area based on individual context information of the audience, and transmitting the calculated context meta information and voice information, among the context information of the audience, to the performance server; and
a virtual audience creation unit for creating individual context information of an audience and transmitting the created individual context information to the audience participation server.

20. The system of claim 19, wherein the audience participation server divides the zone area into multiple zone areas including a main zone and a subzone based on a distance from the audience and transmits context meta information of the main zone and the voice information, among the context information of the audience, to the performance server.
